(19) United States
(12) Patent Application Publication
(10) Pub. No.: US 2005/0262155 A1
(43) Pub. Date: Nov. 24, 2005

(54) Method and apparatus for mapping data types from heterogeneous databases into a single set of data types

(76) Inventors: Daryl J. Kress, Hugo, MN (US); Eugene J. Gretter, Lino Lakes, MN (US)

Correspondence Address: UNISYS CORPORATION;MS 4773, PO BOX 64942, ST. PAUL, MN, 55164-0942, US

(21) Appl. No.: 10/848,668

(22) Filed: May 19, 2004

(51) Int. Cl. G06F 7/00

(52) U.S. Cl. 707/200

(57) ABSTRACT

An apparatus for and method of utilizing service requests to a legacy data base management system to efficiently access external data types. To accomplish this, the external data types are dynamically mapped into data types compatible with the legacy data base management system.

### CROSS REFERENCE TO CO-PENDING APPLICATIONS

U.S. patent application Ser. No. ______, filed ______, and entitled, “Cool Ice OLEDB Consumer Interface”; U.S. patent application Ser. No. ______, filed ______, and entitled, “Cool ICE data Wizard”; U.S. patent application Ser. No. filed ______, and entitled, “Cool ICE Column Profiling”; U.S. patent application Ser. No. ______, filed ______, and entitled, “Stored Procedure”; and U.S. patent application Ser. No. filed ______, and entitled, “Cool ICE State Management” are commonly assigned co-pending applications incorporated herein by reference.

### BACKGROUND OF THE INVENTION

1. Field of the Invention

The present invention generally relates to data base management systems and more particularly relates to enhancements for accessing multiple heterogeneous data bases having external data types by dynamically mapping them into a single data base type.

2. Description of the Prior Art

Data base management systems are well known in the data processing art. Such commercial systems have been in general use for more than 20 years. One of the most successful data base management systems is available from Unisys Corporation and is called the Classic MAPPER® data base management system. The Classic MAPPER system can be reviewed using the Classic MAPPER User's Guide which may be obtained from Unisys Corporation.

The Classic MAPPER system, which runs on proprietary hardware also available from Unisys Corporation, provides a way for clients to partition data bases into structures called filing cabinets and drawers, as a way to offer a more tangible format. The Mapper data base manager utilizes various predefined high-level instructions whereby the data base user may manipulate the data base to generate human-readable data presentations called “reports”. The user is permitted to prepare lists of the various predefined high-level instructions into data base manager programs called “Mapper Script”. Thus, users of the Classic MAPPER system may create, modify, and add to a given data base and also generate periodic and aperiodic reports using various Mapper Script.

However, with the Classic MAPPER system, as well as with similar proprietary data base management systems, the user must interface with the data base using a terminal coupled directly to the proprietary system and must access and manipulate the data using the Mapper Script command language of Classic MAPPER. Ordinarily, that means that the user must either be co-located with the hardware which hosts the data base management system or must be coupled to that hardware through dedicated telephone, satellite, or other data links. Furthermore, the user usually needs to be schooled in the command language of Classic MAPPER (or other proprietary data base management system) to be capable of generating Mapper Script.

Since the advent of large scale, dedicated, proprietary data base management systems, the Internet or world wide web has come into being. Unlike closed proprietary data base management systems, the Internet has become a world wide bulletin board, permitting all to achieve nearly equal access using a wide variety of hardware, software, and communication protocols. Even though some standardization has developed, one of the important characteristics of the world wide web is its ability to constantly accept new and emerging techniques within a global framework. Many current users of the Internet have utilized several generations of hardware and software from a wide variety of suppliers from all over the world. It is not uncommon for current day young children to have ready access to the world wide web and to have substantial experience in data access using the Internet.

Problems arise with legacy data base management system access to various incompatible data bases. To be most useful, there must be the capability to access such preexisting, incompatible data bases. In the past, this has been accomplished by fixed mapping table to convert the format of an existing to data base into another format. Whereas this may work for internal data types, it cannot accommodate external data types.

### SUMMARY OF THE INVENTION

The present invention overcomes the disadvantages of the prior art by providing a method of and apparatus for utilizing the power of a full featured legacy data base management system by a user at a terminal access data from otherwise incompatible heterogeneous data bases including data having external data types. This is achieved using a dynamic mapping technique to map the internal and/or external data types from the existing data base into a data type compatible with the BIS data base, wherein it can be operated upon using all of the tools of the full featured BIS management system.

In accordance with the preferred embodiment of the present invention, a user is permitted to easily operate on data from an existing data base which is otherwise incompatible with the preferred legacy data base management system, BIS. It provides for the registration of external table/view columns or stored procedure parameters and columns from heterogeneous database sources. As the types of these entities varies between database types, this system allows for a mapping mechanism to translate the external type into a BIS type. The mapping provides for a set of rules contained in metadata definitions that are executed to perform a dynamic mapping into the common type, rather than using a fixed mapping table. The dynamic mapping capability allows the rule set to be changed so that mappings can be changed or added to accommodate the use of the external data source.

The heuristics involved with data type mapping should accommodate variation in external data types such as locally defined user types. Furthermore, some external database sources provide other variations in defined data types (for example, and ODBC source passes through a native type that cannot be mapped to one of the predefined ODBC types). Providing a fixed set of rules that define a complete mapping over all the database types, and even different levels of the same database type becomes problematic, due to the extreme variation that can be encountered.

The preferred system solves this problem by providing a mechanism to define and apply a heuristic algorithm that first applies generic database type-mapping rules, which are augmented by rules defined for a specific database. The heuristics are exposed with an API so that an end user can manage and change the mapping mechanism to conform to the needs of different end-user applications. Metadata used to support the mapping mechanism provides a link between the data being mapped, and the rule used to determine the mapping. This referential link allows for changing the rule to map to a different Enterprise Information Integration (EII) data type without impacting all the metadata that references the rule.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a pictographic view of the hardware of the preferred embodiment;

FIG. 2 is a pictorial diagram of the basic command process flow;

FIG. 3 is functional flow diagram for the basic command;

FIG. 4 is a schematic diagram showing the BIS and MRIM components;

FIG. 5 is a detailed flow chart showing the operation of the OLEDB Log-On command;

FIG. 6 is a detailed flow chart showing the operation of the OLEDB insert, update, delete, fetch commands;

FIG. 7 is a detailed flow chart showing the operation of the OLEDB Log-Off command; and

FIG. 8 is a detailed class diagram showing operation of the preferred embodiment.

### DETAILED DESCRIPTION OF THE PREFERRED EMBODIMENTS

The present invention is described in accordance with several preferred embodiments which are to be viewed as illustrative without being limiting. These several preferred embodiments are based upon Series 2200 hardware and operating systems, the Classic MAPPER data base management system, and the BIS/Cool ICE software components, all available from Unisys Corporation. When used herein, OLEDB (On-Line Enterprise Data Base) refers to a COM-based Application Programming Interface (API) designed to provide access to a wide range of data sources. OLEDB includes SQL functionality but also defines interfaces suitable for gaining access to data other than SQL data. COM facilitates application integration by defining a set of standard interfaces. Each interface contains a set of functions that define a contract between the object implementing the interface and the client using it. A UDL file contains the complete connection string information, including the data source, userid, password, and any other information needed to logon to and fetch data.

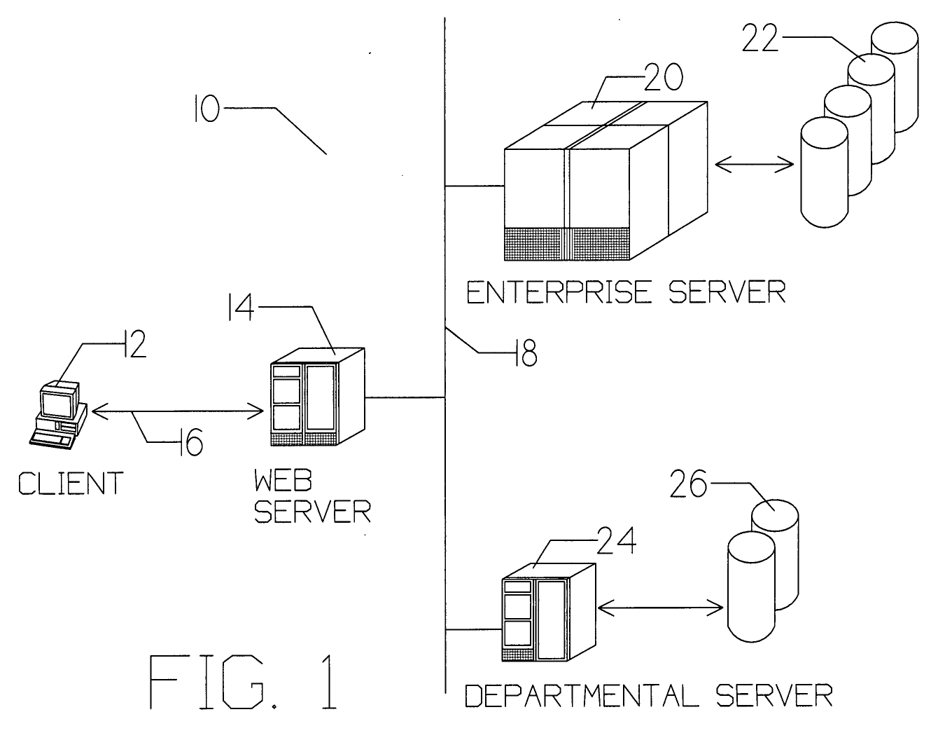

FIG. 1 is a pictorial diagram of hardware suite 10 of the preferred embodiment of the present invention. The client interfaces with the system via Internet terminal 12. Preferably, Internet terminal 12 is an industry compatible, personalized computer having a current version of the Windows operating system and suitable web browser, all being readily available commercial products. Internet terminal 12 communicates over world wide web access 16 using standardized HTML protocol, via Web Server 14.

The BIS/Cool ICE system is resident in Enterprise Server 20 and accompanying storage subsystem 22, which is coupled to Web Server 14 via WAN (Wide Area Network) 18. In the preferred mode, Web Server 14 is owned and operated by the enterprise owning and controlling the proprietary legacy data base management system. Web Server 14 functions as the Internet access provider for Internet terminal 12 wherein world wide web access 16 is typically a dial-up telephone line. This would ordinarily be the case if the shown client were an employee of the enterprise. On the other hand, web server 14 may be a remote server site on the Internet if the shown client has a different Internet access provider. This would ordinarily occur if the shown client were a customer or guest.

In addition to being coupled to WAN 18, Enterprise Server 20, containing the BIS/Cool ICE system, is coupled to departmental server 24 having departmental server storage facility 26. Additional departmental servers (not shown) may be similarly coupled. The enterprise data and enterprise data base management service functionality typically resides within enterprise server 20, departmental server 24, and any other departmental servers (not shown). Normal operation in accordance with the prior art would provide access to this data and data base management functionality.

In the preferred mode of the present invention, access to this data and data base management functionality is also provided to users (e.g., Internet terminal 12) coupled to Intranet 18. As explained below in more detail, web server 14 provides this access utilizing the BIS/Cool ICE system.

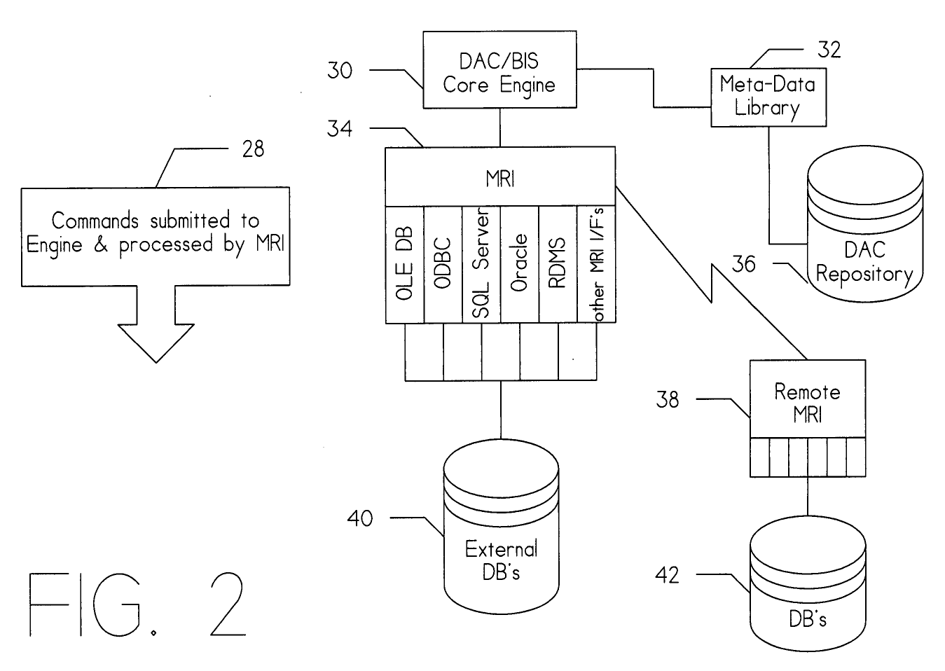

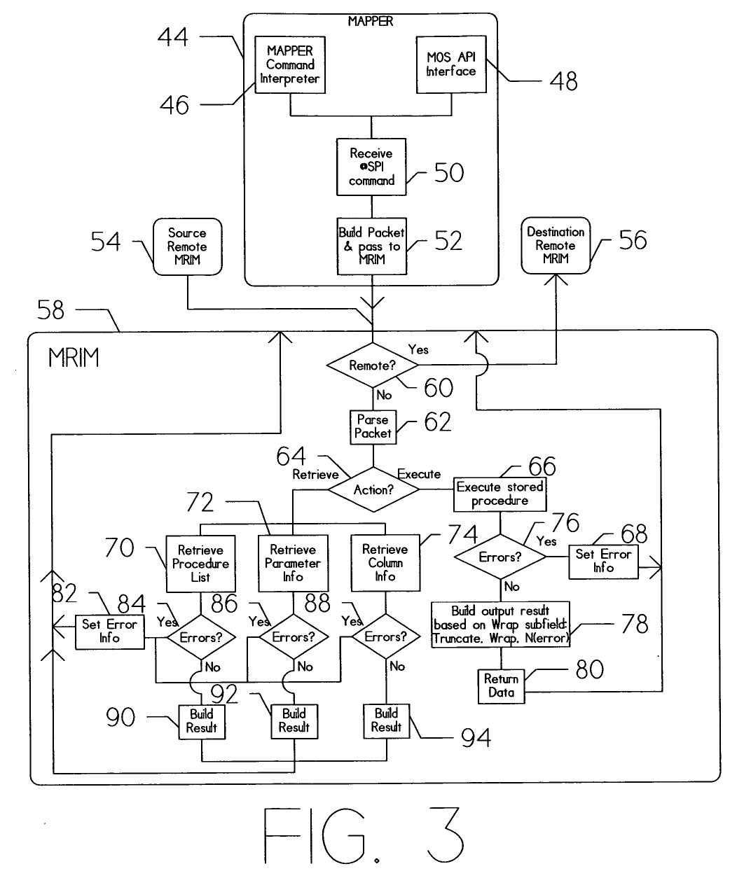

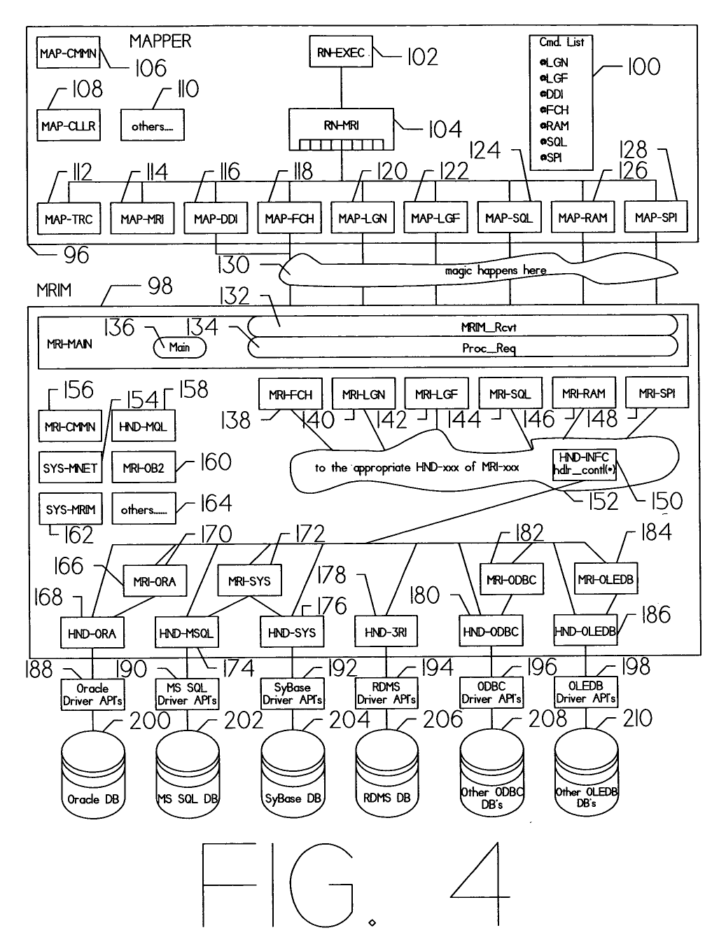

FIG. 2 is a functional diagram showing the major components of the @SPI (stored procedure interface) command process flow. This command is a part of the MRI (BIS Relational Interface) set of commands and combines many of the attributes of the previously existing @FCH (relational aggregate fetch) and @SQL (standard query language) commands. However, it is specifically targeted to executing stored procedures.

Command set 28 represents the commands defined for processing by MRI. In addition to @SPI, @FCH, and @SQL, @LGN (log on), MRI recognizes @LGF (log off), @DDI (data definition information), @RAM (relational aggregate modify), @TRC (trace relational syntax), @MQL (submit SQL syntax to a BIS data base) as the remaining commands. DAC/BIS core Engine 30 provides the basic logic for decode and execution of these commands. MRI 34 has relational access to data via the data base management formats shown to external data bases 40. In addition, MRI 34 can call upon remote MRI 38 to make similar relational access of remote data bases 42.

BIS core engine 30 executes commands utilizing meta-data library 32 and BIS repository 36. Meta-data library 32 contains information about the data within the data base(s). BIS repository 36 is utilized to store command language script and state information for use during command execution.

The @SPI command has the following basic format:
@SPI, c, d, lab, db, edsp?, action, wrap, vert ‘sp-syntax’, vpar1 . . . , vparN, typ1, . . . typN.
Fields c and d refer to the cabinet and drawer, respectively, which hold the result. The lab field contains a label to go to if the status in the vstat variable specifies other than normal completion. The required db field provides the data base name. The edsp? field specifies what is to be done with the result if an error occurs during execution.

The sub-field labeled action defines what action is to be performed. The options include execution, return of procedures lists, etc. The wrap sub-field indicates whether to truncate or wrap the results. The vert sub-field defines the format of the results. The name of the stored procedure is placed into the sp-syntax field. The vpar provides for up to 78 variables that correspond to stored procedure parameters. Finally, the typ field defines the type of each stored procedure parameter.

FIG. 3 is a high-level functional flow diagram for the command. The heart of the system is the BIS Relational Interface Module (MRIM) containing much of the logic for the preferred mode of the present invention. It is provided local data/commands from BIS 44 and remote data/commands from Source Remote MRIM 54. Remote results are forwarded via Destination Remote MRIM 56.

BIS 44 includes the BIS Command Interpreter and MOS API Interface 48 which provide the @SPI command to Receiver 50. The packet is built by element 52 for transfer to MRIM 58.

MRIM 58 receives remote packets from Source Remote MRIM 54. The @SPI command packet is received by element 60, whether local or remote. Remote packets are forwarded via Destination Remote MRIM 56. Local packets are passed to element 62 for parsing. Control is given to element 64 for switching between retrieve commands and execute commands.

Request packets for retrieval are routed to element 70, 72, or 74 depending upon whether it requests a list, parameter information, or column information, respectively. Upon the appropriate retrieval, elements 84, 86, and 88 look for a retrieval error. If yes, control is given to element 82 for setting the error information before exit. If not, control is given to element 90, 92, or 94 for building of the result packet, before exit.

Element 64 routes execution request packets to element 66 for execution of the stored procedure. Element 76 determines whether an error has occurred. If yes, element 68 sets the error information before exit. If not, element 78 builds the output results packet. Element 80 returns the data before exit.

FIG. 4 is a detailed block diagram showing the major components of BIS and MRIM as utilized in accordance with the preferred mode of the present invention. BIS 96 receives command packets as MAP-CMMN 106, MAP-CLLr 108, or others 110. Command List 100 specifies which of the commands are valid and to be executed. These are @LGN (log on), @LGF (log off), @DDI (data definition information), @FCH (relational aggregate fetch),@ RAM (relational aggregate modify), @SQL (standard query language), and SPI (stored procedure interface). These commands are executed using RN-Exec 102, RN-MRI 104, and specialized elements 116, 118, 120, 122, 124, 126, and 128, whereas elements 112 and 114 handle @TRC (trace relational syntax) and information requests. Packets are prepared for all of the listed commands for transfer via interface 130 to MRIM 98.

Interface from BIS 96 to MRIM 98 is handled by MRI-Main 136. The incoming packets are routed via MRIM_Rcvr 132 and Proc_Req 134, as appropriate. Each of the listed commands (see list 100) is assigned to the corresponding one of the request handlers 138, 140, 142, 144, 146, and 148. After unpacking, switch 152, controlled by element 150, routes the information to the appropriate one(s) of the command handlers 166, 168, 170, 172, 174, 176, 178, 180, 182, 184, and 186. Data base command access is via the appropriate one(s) of the data base interfaces 188, 190, 192, 194, 196, and 198 to the specified one(s) of the available data bases 200, 202, 204, 206, 208, and 210. Internal utilities 154, 156, 158, 160, 162, and 164 assist in this process as needed.

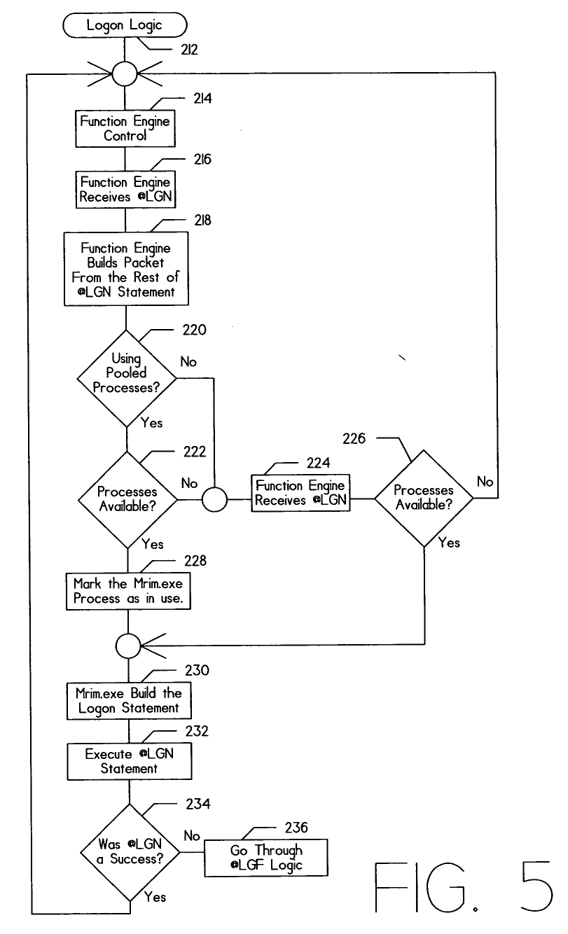

FIG. 5 is a detailed flow chart showing operation of the Log-On command. Entry is via element 212. At element 214, the function engine control begins analysis of the received command. The @LGN command is identified at element 216. The information from the ®LGN command is utilized to build a command packet at element 218. Element 220 determines whether a pooled process is involved. If no, control is given to element 224. If yes, element 222 determines whether the required processes are available. If not control is given to element 224. If available, control is given to element 228.

The @LGN command is provided to the function engine at element 224. If element 226 determines that the needed processes are not available, control is returned to element 214, with no further possible processing of the current command. If the processes are now available, element 226 provides command to element 230.

The Mrim.exe process is marked in use by element 228. At element 230 Mrim.exe builds the actual Log-On statement. This statement is executed at element 232 to perform the log-on function. Element 234 determines whether the execution was successful. If yes, control is returned to element 214 to await the next command. Otherwise control is given to element 236 to go through the @LGN logic.

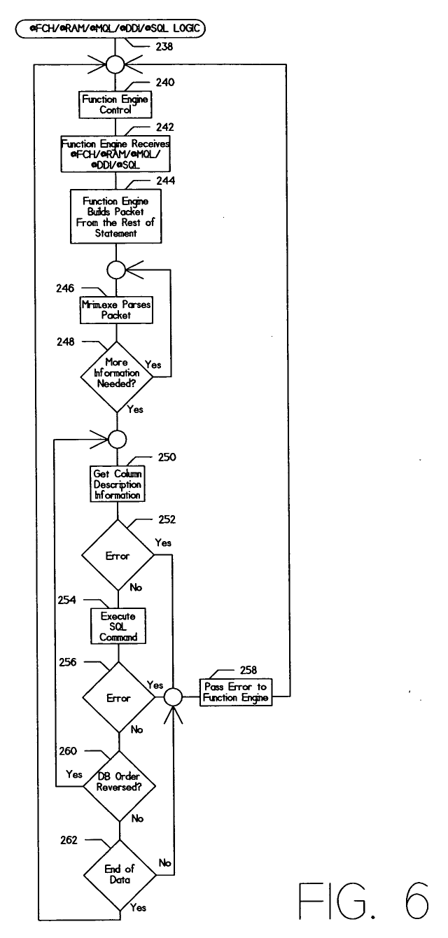

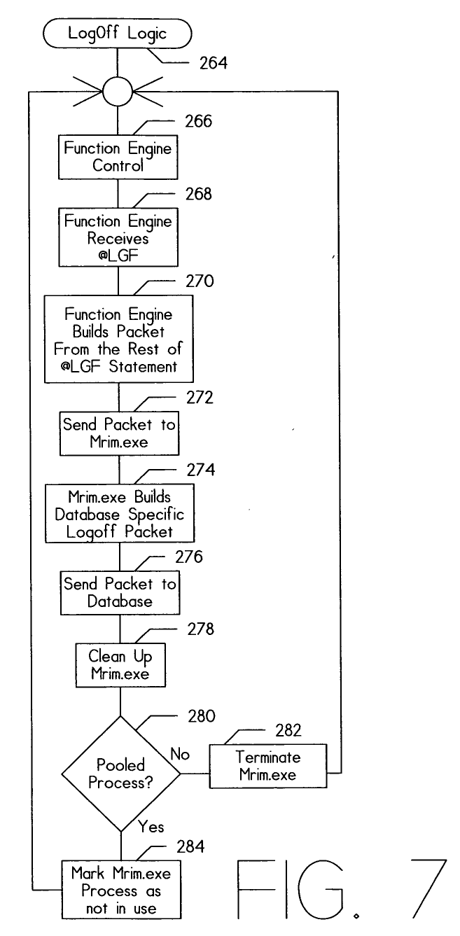

FIG. 6 is a detailed flow chart of operation of the commands which operate upon the OLEDB data. Entry is via element 238. The function engine control is initiated at element 240. The function engine receives the transferred command at element 242. The available commands are: @FCH (fetch); @RAM (relational aggregate modify); @DDI (data definition information); and @SQL (standard query language).

At element 244, the function engine builds a packet from the command statement. MRIM.exe parses the packet at element 246. Element 248 determines whether more information is needed. If yes, control is returned to element 246 for further parsing. If not, control is given to element 250 for obtaining the column information. Element 252 determines whether an error has occurred. If yes, control is given to element 258. If not, element 254 executes the SQL command. If element 256 determines that an error has occurred during the execution, control is given to element 258 for passing the error to the function engine, with control returned to element 240 for the next command.

If no error has occurred in the execution, element 260 determines if the data base order has been reversed. If yes, control is given to element 250 for re-execution of the command. If not, element 262 determines whether all data has been processed. If not, an error has occurred and control is given to element 258 for error processing. If no error, the command has been fully executed properly, and control is returned to element 240 for processing of the next command.

FIG. 7 is a detailed flow chart showing operation of the Log-Off command. Entry is via element 264. The function engine is initiated at element 266. The @LGF command is received at the function engine at element 268. The function engine builds a packet from the @LGF command at element 270.

The @LGF command packet is sent to Mrim.exe at element 272. Mrim.exe builds the data base specific log-off packet at element 274. Element 276 sends the packet to the appropriate data base. Mrim.exe is cleaned up at element 278.

Element 280 determines whether the command is a pooled process. If not, control is given to element 282 for termination of the process, and control is returned to element 266 for a future command. If it is a pooled process, element 280 gives control to element 284 to mark Mrim.exe as not in use. Control is returned to element 266 to await the next command.

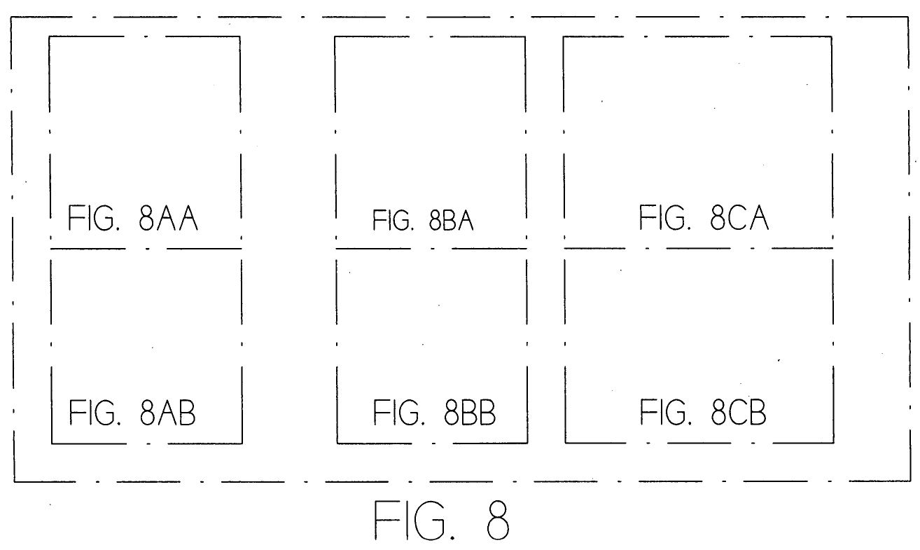

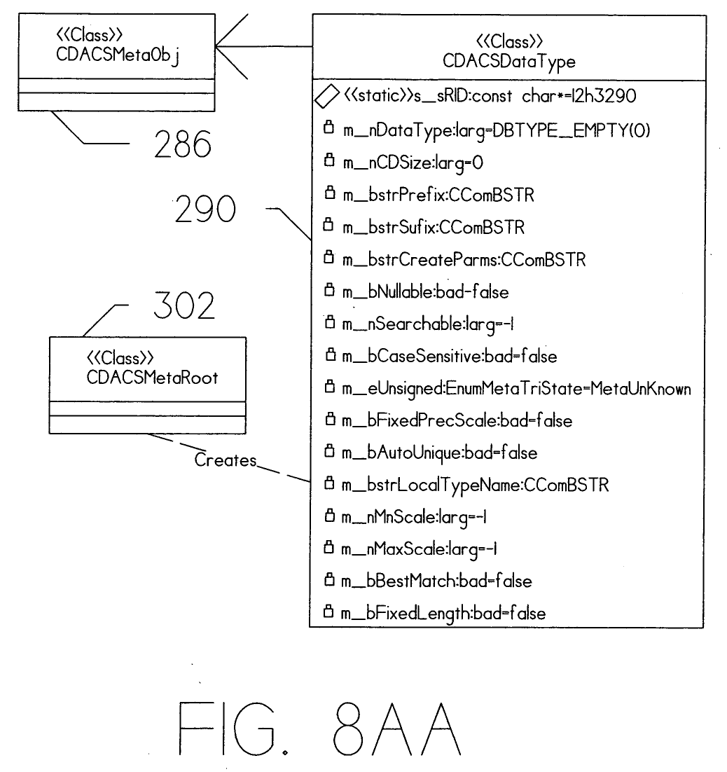

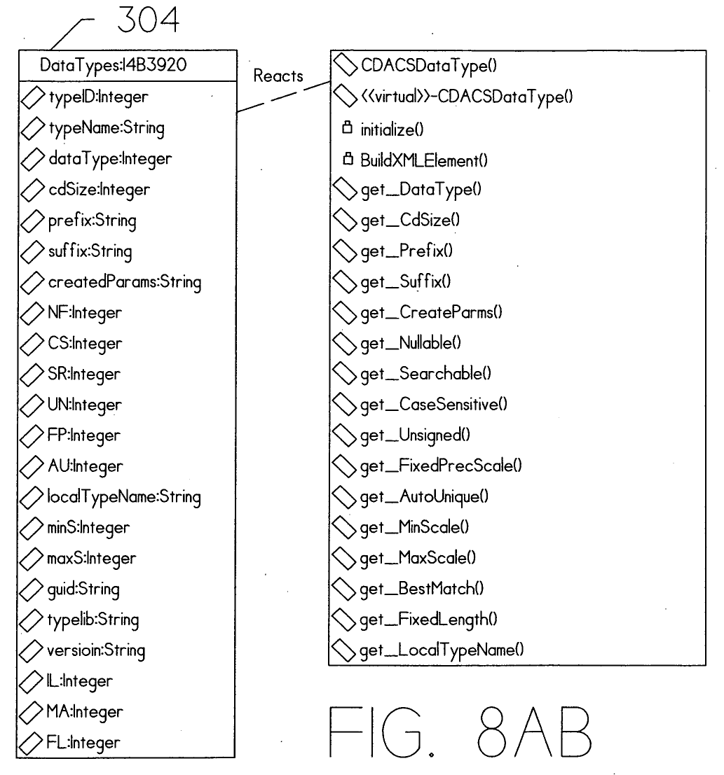

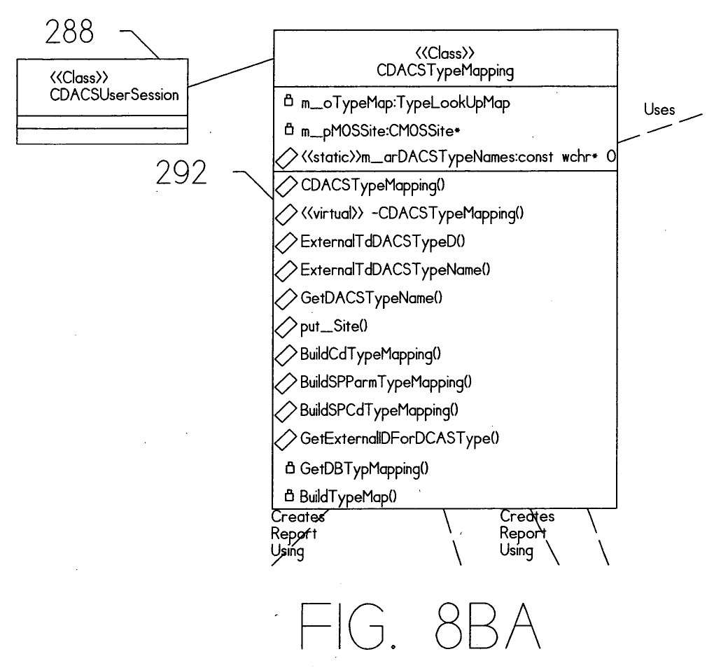

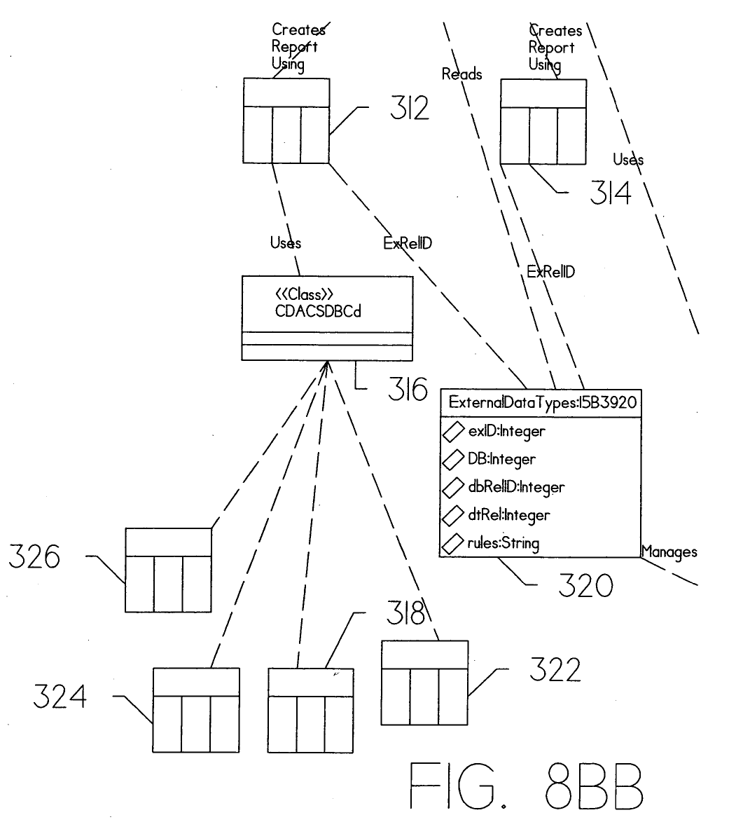

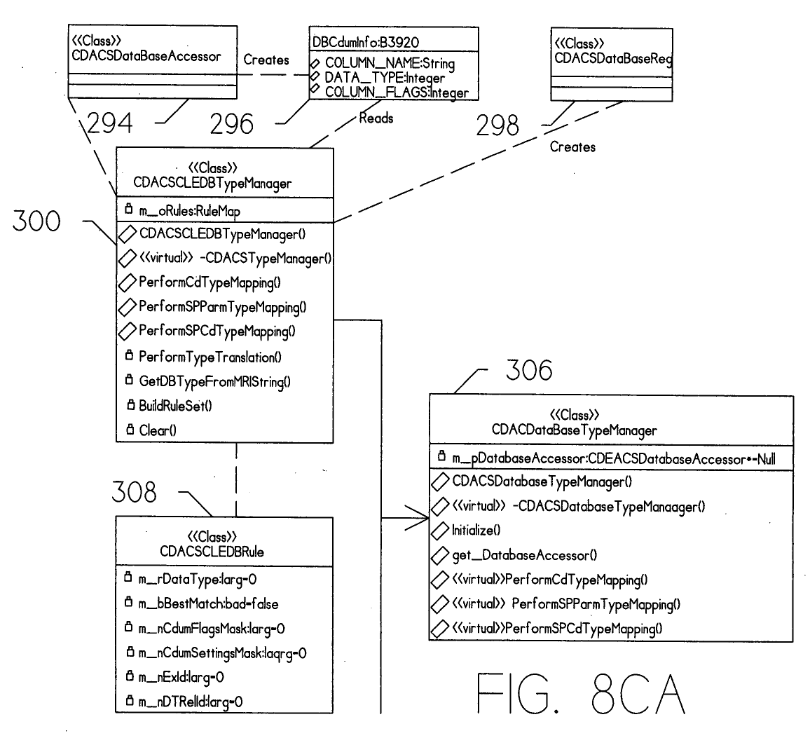

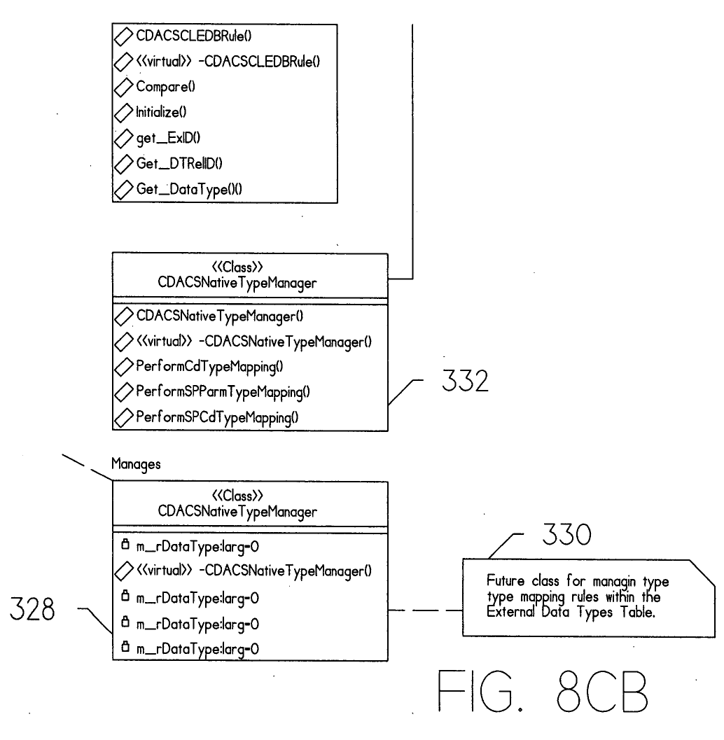

FIG. 8 is a detailed class diagram showing operation of the present invention. Data types are provided for three aspects of EII metadata. First, there is a data type name associated with a column registered for a table or view. In this case, the original data type name comes from an external source and must be mapped to a EII data type. There is a data type name associated with a stored procedure parameter. In this case, the data type may have come from an external stored procedure (requiring mapping to a EII data type), or it may be a native EII data type used for a local javascript or SQL Standard Query Language) stored procedure. There is a data type name associated with a stored procedure column. Similar to the above case, there are both external and internal stored procedure definitions that require mapping or use native data types, respectively.

Secondly, data type mapping is required to map an external data type name into one of the defined EII data types. Database types included in the type mapping provides for OLEDB, ODBC, Native SQL, and Native Oracle, but the model provides that the rules can be extended to other dataset types.

Thirdly, a metadata store, described as the External Data types table, provides the definitions for mapping from an external data type to EII data type, i.e., this table provides the rule set for data type mapping. Each entry in this table represents a mapping rule and the resultant EII data type that the rule maps to. The entry is qualified by the database type that the rule applies to and the specific database registration that the rule applies to. EII registration metadata, that describes data type information, maps to an entry in the External Data Type table, which in turn provides the corresponding EII data type.

To allow the dynamic changes in EII data type associated with the rules, metadata associated with table/view column or stored procedure parameter/column definitions contain a reference to an entry in the External Data Types table rather than the resultant EII data type. Given the entry in the External Data Types table, the EII data type can be determined. Using the index to the rule as a referential entry in the external data type metadata allows for a dynamic mapping so that the EII data type associated with the rule can change, allowing the system to process the external data type as the desired EII data type.

CDACSTypeMapping 292 is the primary class that performs the EII type mapping. It reads metadata contained in External Data Types table 320 to perform the type mapping of a given database, and provides translation to EII type. During registration of columns and parameters, this class reads in rules from ExternalDataType table 320, and uses the appropriate TypeManager class 300, 306, 328, or 332, to provide the link between the column/parameter registration and an entry in External Data Type table 320. A key concept is that metadata registration for entities having a data type do not include a hard-coded data type but rather contain a referential link to an entry in the ExternalDataTypes table 320. This link is established during registration by executing the mapping heuristics logic contained in the type manager classes (300, 308, 332, 306).

The mapping can be dynamically changed by changing information in the ExternalDataType table. During runtime generation of properties of XML (Extended Markup Language) associated with a registered column or parameter, this class provides methods to return the EII type associated with the External Data Types referenced stored with the registration. The GetDBTYPE Mapping method provides an algorithm to search the External Data Types table 4320 for all lines that match both the predefined types and the lines for types specific to the database registration (m-eDBTType matches and dbRefID=m_-nID).

CDACSDatabaseTypeManager 306 is the base class for database type manager classes. This set of classes encapsulates the knowledge of how to interpret the information in the External Data Types table 320 in order to do data type mapping. Each subclass contains the heuristics used to perform the data type mapping for the given database type.

CDACSNative Type Manager 332 is a subclass of the CDACSDatabaseTypeManager, managing data type mapping for native database types. All database types that are not OLE DB use this class for data type mapping. CDACSOLEDBTypeManager 300 is a subclass of the CDACSDatabaseTypeManager, managing data type mapping for OLE DB databases. This class processes a richer set of metadata to perform the type translation and builds instances of CDACSOLEDBRule 308 to represent the rules used in OLE DB type mapping.

CDACSOLEDBRule 308 represents a single rule for an External OLEDB column to EII type translation. This class interprets the information contained in the External Data Types field Rules and knows how to parse the rules field into class attributes. The attributes m_nExID and m_nDTRefID are the corresponding values associated with the rules field. CDACSDataType 290 is the class which represents information in the DataTypes table that provides the description of the EII data types that other types will be mapped to.

CDACSExternalDataType 320 represents information in the External Data Types that define the rule set for type mapping. This class provides the API (application program interface) to manage the data type mapping metadata. The CDACSDatabaseAccessor is responsible for accessing external database metadata, such as external type information and data type characteristics.

### EXAMPLE #1

This example involves querying column information from an external data source and presenting the columns as mapped to local EII data types. This scenario goes through the following steps:
1. Information is pulled from CDACSDatabaseAccessor and mapped to the EII data type (via CDACSTypeMapping:BuildColTypeMapping). CDACSDatabaseAccessor is invoked to return basic column information. It retrieves entries from the External Data Types table for the given database to process type mapping. It performs the column type mapping. A specific subclass of CDACSDatabaseTypeManager knows how to perform the type mapping given the rules in the External Data Types table. A report in the format @FCH,M is generated with extra columns to include the exRefID and dtRefID. The exRefID field points to an entry in the external types, and the dtRefID is the EII data type associated with that entry.
2. Class CDACSDBCol represents the output of the above mapping. This class has the ability to build XML, describing the column information for the column query. Determining the string representation of the dtRefID is done through a call to a CDACSTypeMapping object (method GetDACSTypeName). CDACSTypeMapping provides the ability to associate types with names.

### EXAMPLE #2

This example involves registering information from an external data source into the EII metadata. The registration process will need to provide for presenting the columns as mapped to local EII data types. The following steps are performed:
1. A class associated with metadata registration is called to register columns given an XML document containing column names from an external table or view.
2. Metadata describing the external data source is pulled from CDACSDatabaseAccessor and mapped to the EII data type (via CDACSTypeMapping:BuildColTypeMapping( )—see also Example #1.
3. The current column registration sequence is executed as specified in the above example. The main point is that the exRefID field is recorded in the column registration metadata instead of the original data type associated with the external data source.

Registration of external stored procedure parameters/columns goes through a similar scenario, recording the exRefID in the registration metadata.

### EXAMPLE #3

This example is enacted when any metadata containing the exRefID needs to provide the corresponding EII data type name in either the XML generated for the object or the object properties. This is the case for table and view columns and stored procedure parameters and columns. The following steps are performed:
1. The object is constructed from metadata containing an exRefID as well as an attribute such as m_nExternalTypeRefID that identifies the mapping used to determine the EII data type for this object.
2. This object's BuildXML, method is invoked in response to GetXML, method processing.
3. The CDACSTypeMapping object is retrieved from the user session and requested to provide the EII data type name (method ExternalToDACSTypeName).
4. The type lookup must occur. Given the external type ID, the corresponding EII data type name is required as described in the External Data Types table. The DACSTypeMapping object maintains an STL map (long to long) that maps the exID (key) to EII data type (value). The EII data type can be determined from the external type ID.

Having thus described the preferred embodiments of the present invention, those of skill in the art will be readily able to adapt the teachings found herein to yet other embodiments within the scope of the claims hereto attached.

1. An apparatus comprising:
a. a user which generates a service request;
b. a legacy data base management system having a data type responsively coupled to said user which receives said service request;
c. a legacy data base having external data incompatible with said data type and responsively coupled to said data base management system; and
d. a facility responsively coupled to said legacy data base management system and said legacy data base which permits honoring of said service request by dynamically mapping said external data into said data type.

2. The apparatus of claim 1 wherein said user further comprises a user terminal.

3. The apparatus of claim 2 wherein said legacy data base further comprises a non-OLEDB data base.

4. The apparatus of claim 3 further comprising a publically accessible digital data communication network which responsively couples said user terminal to said legacy data base management system.

5. The apparatus of claim 4 wherein said legacy data base management system further comprises BIS data base management system.

6. A method of accessing an external data type from a legacy data base comprising:
a. transmitting to said to a legacy data base management system a service request requiring access to an external data type;
b. receiving said service request by said legacy data base management system;
c. mapping said external data type into an internal data type cognizable by said legacy data base; and
d. honoring said service request by accessing said external data type.

7. A method according to claim 6 further comprising generating said service request at a user terminal.

8. A method according to claim 7 wherein said user terminal is coupled to said legacy data base management system via a publically accessible digital data communication network.

9. A method according to claim 8 wherein said external data type further comprises a non-OLEDB data base entry.

10. A method according to claim 9 wherein said legacy data base management system further comprises BIS data base management system.

11. An apparatus comprising:
a. permitting means for permitting a user to transfer a service request requiring access to an external data type;
b. offering means responsively coupled to said permitting means for offering legacy data base management services using a scripted command language and having an internal data type; and
c. mapping means responsively coupled to said offering means for mapping said external data type into said internal data type.

12. An apparatus according to claim 11 wherein said permitting means further comprises a user terminal.

13. An apparatus according to claim 12 wherein said external data type further comprises a non-OLEDB data base.

14. An apparatus according to claim 13 wherein said offering means further comprises BIS data base management system.

15. An apparatus according to claim 14 wherein said permitting means further comprises an industry standard personal computer.

16. In a data processing system having a user terminal which generates a service request responsively coupled to a legacy data base management system, the improvement comprising:
a. an external data type incompatible with said legacy data base management system and responsively coupled thereto; and
b. a facility responsively coupled between said legacy data base management system and said external data type for mapping said external data type to a form compatible with said legacy data base.

17. The improvement according to claim 16 wherein said service request requires access to said external data type.

18. The improvement according to claim 17 further comprising a publically accessible digital data communication network which responsively couples said user terminal to said legacy data base management system.

19. The improvement according to claim 18 wherein said legacy data base management system further comprises the BIS data base management system.

20. The improvement according to claim 19 wherein said user terminal further comprises an industry compatible personal computer.

21. An apparatus for accessing a database comprising:
a. a user terminal which generates a service request;
b. a BIS type legacy data base management system having a data type responsively coupled to said user terminal via a publically accessible digital data communication network which receives said service request;
c. a legacy non-OLEDB data base having external data incompatible with said data type and responsively coupled to said data base management system; and
d. a facility responsively coupled to said legacy data base management system and said legacy data base which permits honoring of said service request by dynamically mapping said external data into said data type.
